(19) United States
(12) Patent Application Publication
(10) Pub. No.: US 2026/0103379 A1
(43) Pub. Date: Apr. 16, 2026

(54) PROCESS FOR PRODUCING HYDROGEN GAS FROM THE CATALYTIC CRACKING OF AMMONIA

(71) Applicant: JOHNSON MATTHEY PUBLIC LIMITED COMPANY, London (GB)

(72) Inventors: Julie Louise ASHCROFT, Royston Hertfordshire (GB); John David PACH, Billingham Cleveland (GB)

(21) Appl. No.: 19/112,488

(22) PCT Filed: Nov. 15, 2023
(86) PCT No.: PCT/GB2023/052991

§ 371 Date: Mar. 17, 2025

(30) Foreign Application Priority Data
Nov. 16, 2022 (GB) 2217102.9

(51) Int. Cl. C01B 3/047

(52) U.S. Cl. CPC C01B 3/047

(57) ABSTRACT

Process A process for producing hydrogen gas from the catalytic cracking of ammonia. The process comprises the step of supplying a hydrogen containing recycle gas taken from downstream of an ammonia cracking reactor to one or more catalyst containing reaction tubes disposed within the ammonia cracking reactor. The invention may be used to provide hydrogen gas as a non-carbon containing fuel.

### FIELD OF THE INVENTION

The present invention relates to a process for producing hydrogen gas. More specifically, the present invention relates to a process for producing hydrogen gas by catalytically cracking ammonia.

### BACKGROUND OF THE INVENTION

There is renewed interest in using hydrogen as a green, carbon free, fuel in a variety of industrial settings. Hydrogen may be combusted to produce heat energy or electricity using, for example, a gas turbine. Alternatively, hydrogen may be used to produce electrochemical energy in, for example, a fuel cell.

Ammonia has received interest as a possible compound to enable the storage and transport of hydrogen. Liquid ammonia has a higher hydrogen density than liquid hydrogen, and may be transported using existing infrastructure which is already in use for this purpose, such as that used for the transportation of ammonia in the agrochemical fertiliser industry.

Once the liquid ammonia has been transported it may be combusted directly or converted to hydrogen by the process of cracking.

The catalytic cracking of ammonia into hydrogen and nitrogen has been known for many years. The reaction may be depicted as follows:

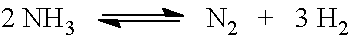

The ammonia cracking reaction is endothermic and may usefully be achieved by passing ammonia over a suitable catalyst in externally heated catalyst-containing reaction tubes disposed in a furnace. Such furnaces are known, for example, for the steam reforming of natural gas or naphtha feedstocks.

However, the heated catalyst-containing reactions tubes disposed in the furnace may react with the ammonia containing gas forming an unwanted metal nitride layer. This unwanted side reaction, known as nitriding, may cause the accelerated failure of the reaction tubes, in particular at the inlet to the reaction tubes. Such failures require a complete shutdown of the ammonia cracking reactor, and result in significant plant down time. Moreover, nitriding and potential failure of the reaction tubes presents a serious safety hazard.

There remains a need for improved processes for the catalytic cracking of ammonia which address the problem of nitriding.

### SUMMARY OF THE INVENTION

The present invention seeks to provide a process for the cracking of ammonia to produce hydrogen whilst reducing the occurrence of nitriding of the catalyst containing reaction tubes disposed within the ammonia cracking reactor.

Accordingly, the present invention provides a process for the catalytic cracking of ammonia, the process comprising:
supplying an ammonia stream to one or more catalyst containing reaction tubes disposed within an ammonia cracking reactor;
cracking the ammonia in the ammonia stream in the one or more catalyst containing reaction tubes disposed within the ammonia cracking reactor to produce a hydrogen containing stream; and
supplying a hydrogen containing recycle gas taken from downstream of the ammonia cracking reactor to the one or more catalyst containing reaction tubes disposed within the ammonia cracking reactor.

It has surprisingly been found that by supplying the hydrogen containing recycle gas taken from downstream of the ammonia cracking reactor to the one or more catalyst containing reaction tubes disposed within the ammonia cracking reactor that the rate of nitriding of the one or more catalyst containing reaction tubes can be reduced, in particular the rate of nitriding at the inlet and the area directly downstream of the inlet to the one or more catalyst containing reaction can be reduced.

Furthermore, whilst supplying the hydrogen containing recycle gas to the one or more catalyst containing reaction tubes disposed within the ammonia cracking reactor would be expected to decrease the amount of ammonia converted to H₂ by shifting the equilibrium position of the ammonia cracking reaction, it has surprisingly been found that the process of the invention not only reduces the rate at which nitriding of the catalyst containing reaction tubes occurs but also provides a process with a high overall H₂ recovery.

In a preferred process of the invention there is provided a process for the catalytic cracking of ammonia, the process comprising:
supplying an ammonia stream to one or more catalyst containing reaction tubes disposed within an ammonia cracking reactor;
cracking the ammonia in the ammonia stream in the one or more catalyst containing reaction tubes disposed within the ammonia cracking reactor to produce a hydrogen containing stream;
feeding the hydrogen containing stream to a purification unit and increasing the H₂ content of the hydrogen containing stream to produce an enriched hydrogen stream and a tail gas; and
supplying a hydrogen containing recycle gas taken from downstream of the ammonia cracking reactor to the one or more catalyst containing reaction tubes disposed within the ammonia cracking reactor,
   wherein the hydrogen containing recycle gas comprises a portion of the enriched hydrogen containing stream.

When the hydrogen containing recycle gas comprises a portion of the enriched hydrogen containing stream, the total gas flow within the process of the invention can be minimised allowing a smaller ammonia cracking reactor to be used, thereby reducing the capital cost of implementing the process of the invention.

### BRIEF DESCRIPTION OF THE DRAWINGS

FIG. 1 shows a block flow diagram of a process not according to the invention.

FIG. 2 shows a block flow diagram according to the process of the invention wherein a portion of an enriched hydrogen containing stream (a recycle gas) is supplied to one or more catalyst containing reaction tubes disposed within ammonia cracking reactor.

FIG. 3 shows a block flow diagram according to the process of the invention, wherein a portion of a hydrogen containing stream (a recycle gas) is supplied to one or more catalyst containing reaction tubes disposed within ammonia cracking reactor.

FIG. 4 shows a block flow diagram according to the process of the invention, wherein a portion of the tail gas produced from a hydrogen purification unit (a recycle gas) is supplied to one or more catalyst containing reaction tubes disposed within ammonia cracking reactor.

FIG. 5 shows the nitriding potential of various gas compositions as they pass through a catalyst containing reaction tube disposed within an ammonia cracking reactor.

FIG. 6 shows a schematic of the compact reactor available from Johnson Matthey Davy Technologies Limited.

### DETAILED DESCRIPTION

Preferred and/or optional features of the invention will now be set out. Any aspect of the invention may be combined with any other aspect of the invention unless the context demands otherwise. Any of the preferred and/or optional features of any aspect may be combined, either singly or in combination, with any aspect of the invention unless the context demands otherwise.

The process of the invention comprises supplying an ammonia stream to one or more catalyst containing reaction tubes disposed within an ammonia cracking reactor.

The ammonia stream may be derived from any source. In preferred processes of the invention, the ammonia stream is produced by the catalytic combination of hydrogen and nitrogen, for example the ammonia stream may be produced from a Haber-Bosch ammonia synthesis process. In preferred processes of the invention the ammonia stream may be produced in an ammonia production facility located upstream of the ammonia cracking reactor. Alternatively, the ammonia stream may be provided from an ammonia gas storage facility, an ammonia storage unit, an ammonia storage tank, or an ammonia gas pipeline.

In preferred processes of the invention the ammonia stream may be pre-heated prior to being supplied to the one or more catalyst containing reaction tubes. Accordingly, the process of the invention may comprise the step of pre-heating the ammonia stream. The ammonia stream may be pre-heated to a temperature of greater than 350° C., greater than 400° C., greater than 450° C., greater than 500° C., or greater than 550° C. The ammonia stream may be pre-heated to a temperature of less than 1000° C., less than 950° C., less than 850° C., less than 750° C., or less than 700° C. The ammonia stream may be pre-heated to a temperature of from 350° C. to 1000° C., from 400° C. to 950° C., from 450° C. to 850° C., or from 500° C. to 750° C., such as from 550° C. to 700° C.

Suitable ammonia cracking reactors are known and may comprise a fuel combustion zone having a radiant section comprising one or more burners to which one or more fuel streams and an oxygen feed gas, such as air, oxygen enriched air, or oxygen, are fed. The radiant section may comprise the one or more catalyst containing reaction tubes though which the ammonia stream is passed. Combustion of one or more fuel streams in the one or more burners of the fuel combustion zone, creates heat energy (e.g. radiant heat) for heating the one or more catalyst containing reaction tubes. There may be tens or hundreds of catalyst containing reaction tubes in the radiant section. If desired, downstream of the radiant section, a flue gas from the combustion of the one or more fuel streams may be used to pre-heat one or more feed streams in a convection section. Reactors comprising a radiant section containing catalyst containing reaction tubes and a convection section for preheating feeds are known in steam methane reforming and may be applied to the present invention

Alternative ammonia cracking reactors may be used, e.g. where the combustion of the one or more fuel streams in a fuel combustion zone is separate to the reactor comprising the catalyst containing reaction tubes. Such a reactor is the compact reformer available from Johnson Matthey Davy Technologies Limited, a schematic of which is shown in FIG. 6.

The catalyst in the catalyst containing reaction tubes may be any ammonia cracking catalyst. For instance, nickel catalysts and/or ruthenium catalysts may be used. Preferred catalysts are nickel catalysts. The catalyst may comprise 3 to 30% by weight nickel, preferably 8 to 20% by weight nickel, expressed as NiO, on a suitable refractory support, such as alumina or a metal aluminate. The catalyst may be in the form of pelleted shaped units, which may comprise one or more through holes, or may be provided as a wash coat on a structured metal or ceramic catalyst. A particularly preferred catalyst is KATALCO® 27-2 available from Johnson Matthey PLC, which comprises 12% nickel, expressed as NiO, on a cylindrical pellet formed from a high surface area calcium aluminate support.

The one or more catalyst containing reaction tubes may suitably be formed of an iron based alloy, a nickel based alloy, or a cobalt based alloy. The iron based alloy may be an iron-chromium based alloy such as a stainless steel, preferably 316 stainless steel, or a high nickel steel such as those described by WO03/051771A1. Preferably, the one or more catalyst containing reaction tubes are formed of a nickel based alloy or a cobalt based alloy More preferably, the one or more catalyst containing reaction tubes are formed of a cobalt based alloy.

The process of the invention comprises cracking the ammonia in the ammonia stream in the one or more catalyst containing reaction tubes disposed within the ammonia cracking reactor to produce a hydrogen containing stream.

The temperature of the ammonia stream at the inlet to the one or more catalyst containing reaction tubes may be in the range of 350° C. to 1000° C., from 400° C. to 950° C., from 450° C. to 850° C., or from 500° C. to 750° C., such as from 550° C. to 700° C. The temperature of the hydrogen containing stream exiting the one or more catalyst containing reaction tubes will influence the equilibrium position of the cracking reaction, and may be in the range of 500 to 950° C. Where nickel catalysts are used in the one or more catalyst containing reaction tubes, the temperature of the hydrogen containing stream exiting the one or more catalyst containing reaction tubes may preferably be greater than about 700° C.

The pressure inlet to the one or more catalyst containing reaction tubes will be set by the flowsheet design and may be in the range 1 to 100 bar absolute, preferably 10 to 90 bar absolute, such as 31 to 51 bar absolute.

The ammonia cracking reaction produces a hydrogen containing stream. The hydrogen containing stream contains H₂. The hydrogen containing stream also contains nitrogen, and may further contain residual ammonia (e.g. unreacted ammonia).

The hydrogen containing stream may comprise 40 mol % or more H₂, 50 mol % or more H₂, or 60 mol % or more H₂. The hydrogen containing stream may comprise 75 mol % or less H₂, 70 mol % or less H₂, or 65 mol % or less H₂. For example, the hydrogen containing stream may comprise from 40 mol % to 75 mol % H₂, from 50 mol % to 70 mol % H₂, or from 60 mol % to 65 mol % H₂.

In preferred processes of the invention, the hydrogen containing stream may be fed to a purification unit, such as a pressure swing absorption unit, to increase the H₂ content by separating H₂ from the other components. The purification unit therefore produces an enriched hydrogen stream and a tail gas. Accordingly, the process of the invention preferably comprises the step of feeding the hydrogen containing stream to a purification unit and increasing the H₂ content of the hydrogen containing stream to produce an enriched hydrogen stream and a tail gas.

It may be preferred that prior to feeding the hydrogen containing stream to the purification unit the hydrogen containing stream is fed to a first steam generation unit and/or a heat recovery zone. As will be understood by the skilled person the first steam generation unit and/or the heat recovery zone may be used to recover low or medium grade heat.

The enriched hydrogen stream may comprise 50 mol % or more H₂, 60 mol % or more H₂, or 75 mol % or more H₂. The enriched hydrogen stream may comprise 100 mol % or less H₂, 90 mol % or less H₂, or 80 mol % or less H₂. For example, the enriched hydrogen stream may comprise from 50 mol % to 100 mol % H₂, from 60 mol % to 90 mol % H₂, or from 70 mol % to 80 mol % H₂, such as about 75 mol % H₂.

The tail gas may comprise nitrogen with small amounts of ammonia and hydrogen. The tail gas may comprise from 1 mol % to 10 mol % ammonia (e.g. about 5 mol % ammonia or less). The tail gas may comprise from 1 mol % to 50 mol % H₂, from 2 mol % to 40 mol % H₂. For instance, the tail gas may comprise from 15 mol % to 25 mol % H₂.

As used herein, the term “hydrogen containing stream” may be used to refer to either the hydrogen containing stream or the enriched hydrogen stream.

The process of the invention comprises the step of supplying a hydrogen containing recycle gas taken from downstream of the ammonia cracking reactor to the one or more catalyst containing reaction tubes disposed within the ammonia cracking reactor.

The hydrogen containing recycle gas is taken from downstream of the ammonia cracking reactor. In preferred processes of the invention the hydrogen containing recycle gas comprises one or more of: a portion of the hydrogen containing stream, a portion of the enriched hydrogen containing stream, and/or a portion of the tail gas from the purification unit used to increase the H₂ content of the hydrogen containing stream. In more preferred processes of the invention the hydrogen containing recycle gas comprises one or more of: a portion of the hydrogen containing stream and/or a portion of the enriched hydrogen containing stream. In most preferred processes of the invention the hydrogen containing recycle gas comprises a portion of the enriched hydrogen containing stream.

When the hydrogen containing recycle gas comprises a portion of the enriched hydrogen containing stream, the total gas flow within the process of the invention can be minimised allowing a smaller ammonia cracking reactor to be used, thereby reducing the capital cost of implementing the process of the invention.

A further advantage of using a hydrogen containing recycle gas which comprises a portion of the enriched hydrogen containing stream is that it has surprisingly been found that hydrogen (H₂) is more efficient at reducing nitriding as compared to other products of the ammonia cracking reaction (for example the tail gas or a nitrogen (N₂) gas stream). Without being bound by any sort of theory, it is believed that hydrogen inhibits nitriding by a different mechanism to that of nitrogen (N₂).

In certain processes of the invention the recycle gas may consist of one or more of: a portion of the hydrogen containing stream, a portion of the enriched hydrogen containing stream, and/or a portion of a tail gas from a purification unit used to increase the H₂ content of the hydrogen containing stream. In certain processes of the invention the recycle gas may consist of one or more of: a portion of the hydrogen containing stream and/or a portion of the enriched hydrogen containing stream. In certain processes of the invention the recycle gas may consist of, or consist essentially of, the enriched hydrogen containing stream.

As will be readily understood, where the hydrogen containing recycle gas comprises a portion of the tail gas from the purification unit used to increase the H₂ content of the hydrogen stream, the process of the invention comprises the step of feeding the hydrogen containing stream to a purification unit and increasing the H₂ content of the hydrogen containing stream to produce an enriched hydrogen stream and a tail gas. However, it will also be understood that where the hydrogen containing stream is fed to a purification unit the hydrogen containing recycle gas may comprise one or more of, or may consist of one or more of, the hydrogen containing stream, the tail gas, and/or the enriched hydrogen containing stream.

The hydrogen containing recycle gas may be fed directly to the one or more catalyst containing reaction tubes or may first be combined with the ammonia containing stream before being fed to the one or more catalyst containing reaction tubes. The hydrogen containing recycle gas may be subject to an intermediate process step, for instance a heat recovery step, prior to being fed to the one or more catalyst containing tubes.

The hydrogen containing recycle gas may be supplied to the one or more catalyst containing reaction tubes such that less than 50 mol % H₂, less than 40 mol % H₂, less than 30 mol % H₂, less than 20 mol % H₂, or less than 10 mol % H₂ is supplied to the one or more catalyst containing reaction tubes.

The hydrogen containing recycle gas may be supplied to the one or more catalyst containing reaction tubes such that greater than 0.5 mol % H₂, greater than 1 mol % H₂, greater than 2 mol % H₂, greater than 4 mol % H₂, or greater than 5 mol % H₂ is supplied to the one or more catalyst containing reaction tubes.

In preferred processes of the invention the hydrogen containing recycle gas may be supplied to the one or more catalyst containing reaction tubes such that from 0.5 mol % to 50 mol % H₂, from 1 mol % to 40 mol % H₂, from 2 mol % to 30 mol %, or from 4 mol % to 20 mol % H₂, or mol % to 10 mol % H₂ is supplied to the one or more catalyst containing reaction tubes.

For the avoidance of doubt, it will be understood that the mol % H₂ in the hydrogen containing recycle gas is expressed as a percentage of the total gas being supplied to the one or more catalyst containing reaction tubes disposed within the ammonia cracking reactor.

It has surprisingly been found that when the hydrogen containing recycle gas is supplied to the one or more catalyst containing reaction tubes in an amount as specified hereinabove that a reduction in the rate of nitriding of the catalyst containing reaction tubes, in particular at the inlet to the catalyst containing reaction tubes, can be achieved whilst maintaining a high overall hydrogen recovery. It has surprisingly been found that supplying up to 50 mol % H₂, such as up to 40 mol %, 30 mol %, 20 mol %, or 10 mol % H₂, to the one or more catalyst containing reaction tubes has a minimal or almost no effect on the overall hydrogen recovery of the process. In other words, it has surprisingly been found that the same or similar overall hydrogen recovery may be achieved using the process of the invention, where a portion of the hydrogen containing recycle gas is supplied to the one or more catalyst containing reaction tubes, as when no hydrogen containing gas is supplied to the one or more catalyst containing reaction tubes.

For the avoidance of doubt, reference to supplying the ammonia containing stream, the hydrogen containing stream, and/or the enriched hydrogen containing stream to the one or more catalyst containing reaction tubes refers to supplying the stream or streams through the catalyst bed of the catalyst containing reaction tubes and does not refer to supplying any one of these streams as a combustible fuel source for providing heat energy to the one or more catalyst containing reaction tubes. It will further be understood that the “total gas being supplied to the one or more catalyst containing reaction tubes” comprises all gases being fed through the catalyst bed of the catalyst containing reaction tubes and does not refer to gas being supplied as a combustible fuel source for providing heat energy to the one or more catalyst containing reaction tubes.

In certain processes of the invention, the hydrogen containing recycle gas may be fed to a second steam generation unit and/or a heat recovery zone before it is supplied to the one or more catalyst containing reaction tubes. As will be understood by the skilled person the second steam generation unit and/or the heat recovery zone may be used to recover low or medium grade heat.

For the avoidance of doubt the first steam generation unit and/or the heat recovery zone and the second steam generation unit and/or the heat recovery zone may be the same or different steam generation units and/or the heat recovery zones.

In the process of the invention, one or more fuel streams may be combusted with oxygen in a fuel combustion zone such that the combustion provides heat energy which is used to support the endothermic ammonia cracking reaction in the ammonia cracking reactor. Accordingly, the process of the invention may comprise the step of combusting one or more fuel streams with oxygen in a fuel combustion zone to provide heat energy to the ammonia cracking reactor.

Alternatively, an electric heater may provide heat energy which is used to support the endothermic ammonia cracking reaction in the ammonia cracking reactor.

The fuel combustion zone may be within the ammonia cracking reactor or may be within a separate vessel for the combustion which is fluidly connected to the ammonia cracking reactor.

The fuel combustion zone may suitably be a radiant section in a furnace box of the ammonia cracking reactor. The fuel combustion zone may therefore provide heat energy (e.g. radiant heat) to the ammonia cracking reactor. Alternatively, if the fuel combustion zone is in a vessel separate from the ammonia cracking reactor, the ammonia cracking reactor may be of a heat exchange design, such as a gas-heated reformer or compact reformer, where the one or more catalyst containing reaction tubes are heated by convection from the hot combustion gas passing around the exterior surfaces of the catalyst containing reaction tubes.

The one or more fuel streams may comprise one or more fuel streams which are combusted with oxygen to produce heat. Preferably, the one or more fuel sources may comprise carbon-free fuel sources (e.g. hydrogen or ammonia). It may be preferred that the one or more fuel sources do not comprise carbon containing fuel sources.

The one or more fuel streams may comprise one or more of hydrogen, natural gas, methane, refinery off gas, biogas, the tail gas from the hydrogen purification unit, a fuel portion of the hydrogen containing stream from the ammonia cracking reactor, or a fuel portion of the enriched hydrogen containing stream from the purification unit.

The oxygen used to combust the one or more fuel streams may suitably be or comprise air, compressed air, oxygen enriched air, oxygen, oxygen and an inert gas such as nitrogen.

As used herein, the term “fuel portion” is used to refer to a portion of a stream (for example the hydrogen containing stream, the enriched hydrogen containing stream, or the ammonia containing stream) which is used as a fuel source. It is not used to refer to a portion of a stream used in the ammonia cracking reaction.

In preferred processes of the invention, the one or more fuel streams may comprise a hydrogen containing fuel stream. Preferably, the hydrogen containing fuel stream may be a fuel portion of the hydrogen containing stream produced from the ammonia cracking reactor. More preferably, the hydrogen containing fuel stream may be a fuel portion of the enriched hydrogen containing stream from the purification unit. Accordingly, the process of the invention may comprise the step of taking a fuel portion of the hydrogen containing stream or a fuel portion of the enriched hydrogen stream, and combusting the fuel portion of the hydrogen containing stream or the fuel portion of the enriched hydrogen containing stream with oxygen in a fuel combustion zone to provide heat energy to support the endothermic ammonia cracking reaction in the ammonia cracking reactor.

The amount of hydrogen in the one or more fuel streams is not particularly limited. For instance, the one or more fuel streams may comprise hydrogen in an amount of from 1 mol % to 100 mol % H₂, such as from 5 mol % to 75 mol % H₂, from 10 mol % to 50 mol % H₂, or from 15 mol % to 30 mol % H₂. Preferably, the one or more fuel streams may comprise hydrogen in an amount greater than 10 mol % H₂, greater than 12 mol % H₂, or greater than 15 mol % H₂. Preferably, the one or more fuel streams may comprise hydrogen in an amount less than 45 mol % H₂, less than 35 mol % H₂, or less than 35 mol % H₂. For instance, the one or more fuel streams may preferably comprise hydrogen in an amount of from 10 mol % to 45 mol % H₂, from 12 mol % to 35 mol % H₂, or from 15 mol % to 25 mol % H₂.

In preferred processes of the invention the one or more fuel streams comprise an ammonia containing fuel stream. The amount of ammonia in the one or more fuel streams is not particularly limited. For instance, the one or more fuel streams may comprise ammonia in an amount of from 1 mol % to 100 mol %, such as from 5 mol % to 75 mol %, from 10 mol % to 50 mol %, or from 15 mol % to 30 mol %. Preferably, the one or more fuel streams may comprise ammonia in an amount greater than 10 mol %, greater than 12 mol %, or greater than 15 mol %. Preferably, the one or more fuel streams may comprise ammonia in an amount less than 45 mol %, less than 35 mol %, or less than 35 mol %. For instance, the one or more fuel streams may preferably comprise ammonia in an amount of from 10 mol % to 45 mol %, from 12 mol % to 35 mol %, or from 15 mol % to 25 mol %.

When the one or more fuel streams comprises ammonia, the ammonia containing fuel stream may be supplied from the same or a different source as the ammonia stream being supplied to the one or more catalyst containing reaction tubes. When the one or more fuel streams comprises ammonia, the ammonia containing fuel stream may be preferably supplied from the same source as the ammonia stream being supplied to the one or more catalyst containing reaction tubes.

In preferred processes of the invention the one or more fuel streams may be pre-heated prior to being combusted in the fuel combustion zone. The one or more fuel streams may be pre-heated to any temperature below the auto ignition temperature of the fuel stream. For instance, the one or more fuel streams may be pre-heated to a temperature greater than 100° C., greater than 150° C., or greater than 200° C. The one or more fuel streams may be pre-heated to a temperature less than the auto ignition temperature of the fuel stream, such as less than 400° C., less than 350° C., or less than 300° C. For example, the one or more fuel streams may be pre-heated to a temperature of from 100° C. to the auto ignition temperature of the fuel stream, such as from 100° C. to 400° C. In preferred processes of the invention the one or more fuel streams may be the ammonia containing fuel stream and may be provided from the pre-heated ammonia stream.

For the avoidance of doubt the one or more fuel streams may be combined prior to combustion, or may be combined at a single point of combustion.

The combustion of the one or more fuel streams in the fuel combustion zone generates a flue gas, which may be recovered from the ammonia cracking reactor. The flue gas may be cooled in one or more cooling stages and may be subjected to one or more purification stages before being discharged to atmosphere. The one or more cooling stages may include a preheating stage for one or more of the reactants for the ammonia cracking reactor and/or generating steam. The one or more purification stages may include a stage of selective catalytic reduction, or SCR, in which nitrogen oxides are reacted with ammonia to form nitrogen and water vapour. Any flue-gas selective catalytic reduction technology may be used.

In certain embodiments of the process of the invention the process comprises the steps of: supplying an ammonia stream to one or more catalyst containing reaction tubes disposed within an ammonia cracking reactor;
cracking the ammonia in the ammonia stream in the one or more catalyst containing reaction tubes disposed within the ammonia cracking reactor to produce a hydrogen containing stream; and
supplying a hydrogen containing recycle gas taken from downstream of the ammonia cracking reactor to the one or more catalyst containing reaction tubes disposed within the ammonia cracking reactor,
wherein the hydrogen containing recycle gas comprises a portion of the hydrogen containing stream.

In certain embodiments of the process of the invention the process comprises the steps of:
supplying an ammonia stream to one or more catalyst containing reaction tubes disposed within an ammonia cracking reactor;
cracking the ammonia in the ammonia stream in the one or more catalyst containing reaction tubes disposed within the ammonia cracking reactor to produce a hydrogen containing stream;
feeding the hydrogen containing stream to a purification unit and increasing the H₂ content of the hydrogen containing stream to produce an enriched hydrogen stream and a tail gas; and
supplying a hydrogen containing recycle gas taken from downstream of the ammonia cracking reactor to the one or more catalyst containing reaction tubes disposed within the ammonia cracking reactor,
   wherein the hydrogen containing recycle gas comprises one or more of: a portion of the hydrogen containing stream, a portion of the enriched hydrogen containing stream, or a portion of the tail gas from the purification unit.

In certain embodiments of the process of the invention the process comprises the steps of:
supplying an ammonia stream to one or more catalyst containing reaction tubes disposed within an ammonia cracking reactor;
cracking the ammonia in the ammonia stream in the one or more catalyst containing reaction tubes disposed within the ammonia cracking reactor to produce a hydrogen containing stream;
optionally, feeding the hydrogen containing stream to a first steam generation unit and/or a heat recovery zone;
optionally, feeding the hydrogen containing stream to a purification unit and increasing the H₂ content of the hydrogen containing stream to produce an enriched hydrogen stream and a tail gas;
optionally, feeding the enriched hydrogen containing stream to a second steam generation unit and/or a heat recovery zone;
supplying a hydrogen containing recycle gas taken from downstream of the ammonia cracking reactor to the one or more catalyst containing reaction tubes disposed within the ammonia cracking reactor;
taking a fuel portion of the hydrogen containing stream or a fuel portion of the enriched hydrogen stream; and
combusting the fuel portion of the hydrogen containing stream or the fuel portion of the enriched hydrogen containing stream with oxygen in a fuel combustion zone to provide heat energy to support the endothermic ammonia cracking reaction in the ammonia cracking reactor,
   wherein the hydrogen containing recycle gas comprises one or more of: a portion of the hydrogen containing stream, a portion of the enriched hydrogen containing stream, or a portion of the tail gas from the purification unit.

In certain embodiments of the process of the invention the process comprises the steps of:
optionally, pre-heating an ammonia stream;
supplying the ammonia stream to one or more catalyst containing reaction tubes disposed within an ammonia cracking reactor;
cracking the ammonia in the ammonia stream in the one or more catalyst containing reaction tubes disposed within the ammonia cracking reactor to produce a hydrogen containing stream;
optionally, feeding the hydrogen containing stream to a first steam generation unit and/or a heat recovery zone;
optionally, feeding the hydrogen containing stream to a purification unit and increasing the H₂ content of the hydrogen containing stream to produce an enriched hydrogen stream and a tail gas;
optionally, feeding the enriched hydrogen containing stream to a second steam generation unit and/or a heat recovery zone;
supplying a hydrogen containing recycle gas taken from downstream of the ammonia cracking reactor to the one or more catalyst containing reaction tubes disposed within the ammonia cracking reactor;
taking a fuel portion of the hydrogen containing stream or a fuel portion of the enriched hydrogen stream; and
combusting the fuel portion of the hydrogen containing stream or the fuel portion of the enriched hydrogen containing stream with oxygen in a fuel combustion zone to provide heat energy to support the endothermic ammonia cracking reaction in the ammonia cracking reactor,
   wherein the hydrogen containing recycle gas may comprises one or more of: a portion of the hydrogen containing stream, a portion of the enriched hydrogen containing stream, or a portion of the tail gas from the purification unit

The invention will now be described in further detail with reference to the following non-limiting embodiments.

FIG. 1 illustrates a block flow diagram of a process not according to the invention. FIG. 1 shows a step of pre-heating ammonia (1) to produce an ammonia containing stream (101). The ammonia containing stream (101) is supplied to the one or more catalyst containing reaction tubes disposed within the ammonia cracking reactor (2). The ammonia in the ammonia containing stream is cracked in the one or more catalyst containing reaction tubes disposed within the ammonia cracking reactor (2) to produce a hydrogen containing stream (102). The hydrogen containing stream (102) is passed to a first steam generation unit and/or a heat recovery zone (3) where heat energy is recovered. The cooled hydrogen containing stream (103) is passed to a purification unit (4) where the H₂ content of the hydrogen containing stream is enriched. The enriched hydrogen stream is recovered as purified hydrogen (5) and a fuel portion of the enriched hydrogen containing stream (105) is passed to a fuel combustion zone (6) of the ammonia cracking reactor (2). The enriched hydrogen containing stream (105) is combusted with oxygen (106), supplied as compressed air from a compressor (7), to produce heat energy (108) which is supplied to the ammonia cracking reactor (2) to support the endothermic ammonia cracking reaction. The ammonia cracking reactor (2) produces a flue gas (109) from which heat energy may be recovered in a second steam generation unit and/or a heat recovery zone (8). The cooled flue gas (110) may be discharged to atmosphere via a stack or sent for further treatment (9).

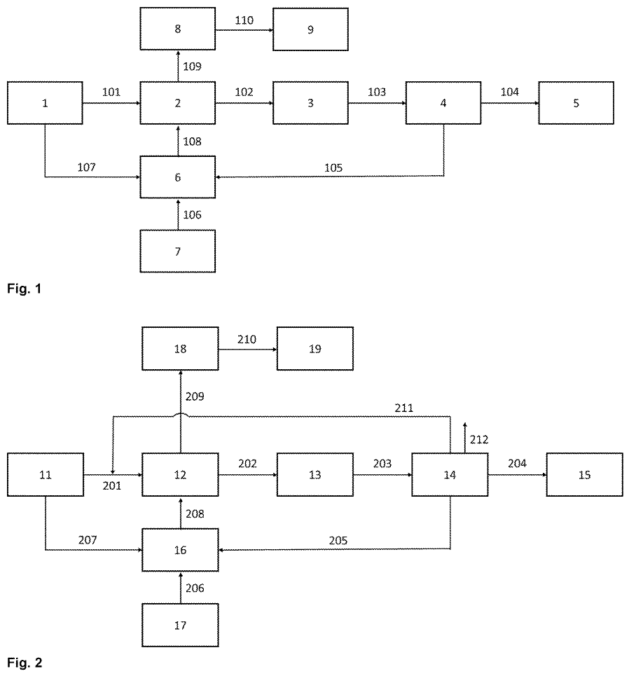

FIG. 2 illustrates a block flow diagram of a process according to the invention. FIG. 2 shows a step of pre-heating ammonia (11) to produce an ammonia containing stream (201). The ammonia containing stream (201) is supplied to the one or more catalyst containing reaction tubes disposed within the ammonia cracking reactor (12). The ammonia in the ammonia containing stream is cracked in the one or more catalyst containing reaction tubes disposed within the ammonia cracking reactor (12) to produce a hydrogen containing stream (202). The hydrogen containing stream (202) is passed to a first steam generation unit and/or a heat recovery zone (13) where heat energy is recovered. The cooled hydrogen containing stream (203) is passed to a purification unit (14) where the H₂ content of the hydrogen containing stream is enriched. The enriched hydrogen stream is recovered as purified hydrogen (15) and a fuel portion of the enriched hydrogen containing stream (205) is passed to a fuel combustion zone (16) of the ammonia cracking reactor (12). The hydrogen purification unit (14) produces a tail gas (212). A portion of the enriched hydrogen containing stream (211) is combined with the ammonia containing stream (201) and fed to the one or more catalyst containing reaction tubes disposed within the ammonia cracking reactor (12). The enriched hydrogen containing stream (205) is combusted with oxygen (206), supplied as compressed air from a compressor (17), to produce heat energy (208) which is supplied to the ammonia cracking reactor (12) to support the endothermic ammonia cracking reaction. The ammonia cracking reactor (12) produces a flue gas (209) from which heat energy may be recovered in a second steam generation unit and/or a heat recovery zone (18). The cooled flue gas (210) may be discharged to atmosphere via a stack or sent for further treatment (19).

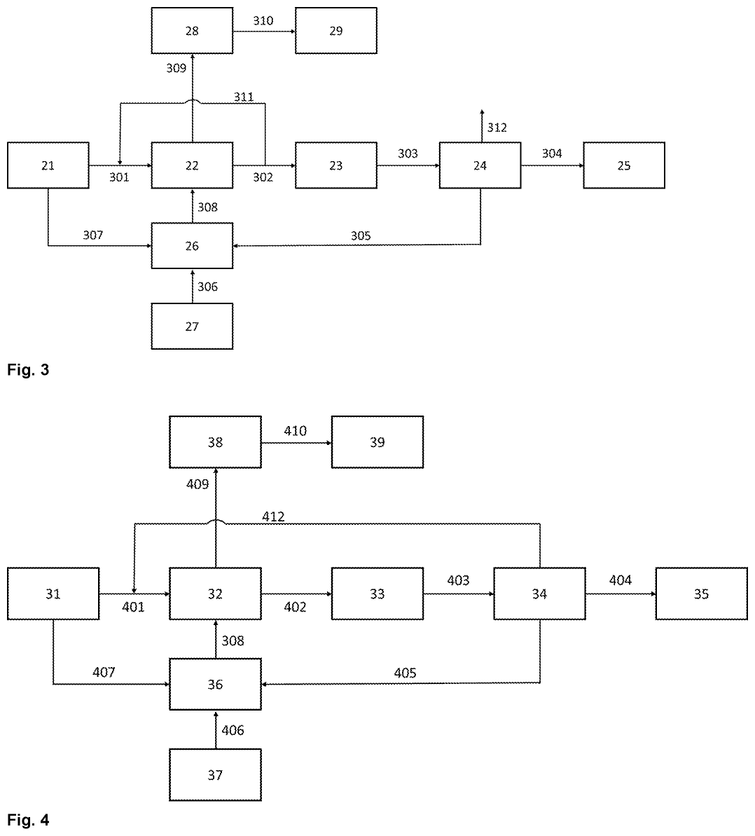

FIG. 3 illustrates a block flow diagram of a process according to the invention where a portion of the hydrogen containing stream (311) is supplied to the one or more catalyst containing reaction tubes disposed within the ammonia cracking reactor (22) prior to purification of the hydrogen containing stream. FIG. 3 shows a step of pre-heating ammonia (21) to produce an ammonia containing stream (301). The ammonia containing stream (301) is supplied to the one or more catalyst containing reaction tubes disposed within the ammonia cracking reactor (22). The ammonia in the ammonia containing stream is cracked in the one or more catalyst containing reaction tubes disposed within the ammonia cracking reactor (22) to produce a hydrogen containing stream (302). A portion of the hydrogen containing stream (311) is combined with the ammonia containing stream (301) and fed to the one or more catalyst containing reaction tubes disposed within the ammonia cracking reactor (22). The rest of the hydrogen containing stream (302) is passed to a first steam generation unit and/or a heat recovery zone (23) where heat energy is recovered. The cooled hydrogen containing stream (303) is passed to a purification unit (24) where the H₂ content of the hydrogen containing stream is enriched and a tail gas (312) is produced. The enriched hydrogen stream is recovered as purified hydrogen (25) and a fuel portion of the enriched hydrogen containing stream (305) is passed to a fuel combustion zone (26) of the ammonia cracking reactor (22). The enriched hydrogen containing stream (305) is combusted with oxygen (306), supplied as compressed air from a compressor (27), to produce heat energy (308) which is supplied to the ammonia cracking reactor (22) to support the endothermic ammonia cracking reaction. The ammonia cracking reactor (22) produces a flue gas (309) from which heat energy may be recovered in a second steam generation unit and/or a heat recovery zone (28). The cooled flue gas (310) may be discharged to atmosphere via a stack or sent for further treatment (29).

FIG. 4 illustrates a block flow diagram of a process according to the invention. FIG. 4 shows a step of pre-heating ammonia (31) to produce an ammonia containing stream (401). The ammonia containing stream (401) is supplied to the one or more catalyst containing reaction tubes disposed within the ammonia cracking reactor (32). The ammonia in the ammonia containing stream is cracked in the one or more catalyst containing reaction tubes disposed within the ammonia cracking reactor (32) to produce a hydrogen containing stream (402). The hydrogen containing stream (402) is passed to a first steam generation unit and/or a heat recovery zone (33) where heat energy is recovered. The cooled hydrogen containing stream (403) is passed to a purification unit (34) where the H₂ content of the hydrogen containing stream is enriched. The enriched hydrogen stream is recovered as purified hydrogen (35) and a fuel portion of the enriched hydrogen containing stream (405) is passed to a fuel combustion zone (36) of the ammonia cracking reactor (32). A portion of the tail gas (412) from the purification unit (34) is combined with the ammonia containing stream (401) and fed to the one or more catalyst containing reaction tubes disposed within the ammonia cracking reactor (32). The enriched hydrogen containing stream (405) is combusted with oxygen (406), supplied as compressed air from a compressor (37), to produce heat energy (408) which is supplied to the ammonia cracking reactor (32) to support the endothermic ammonia cracking reaction. The ammonia cracking reactor (32) produces a flue gas (409) from which heat energy may be recovered in second steam generation unit and/or a heat recovery zone (38). The cooled flue gas (410) may be discharged to atmosphere via a stack or sent for further treatment (39).

### EXAMPLES

### Example 1

Example 1 concerns a fired ammonia cracking reactor being supplied with an ammonia containing stream. The ammonia containing stream enters the reactor at 550° C. and undergoes an ammonia cracking reaction to produce the hydrogen stream which comprises ammonia in an amount of ≤1.1 mol %.

Hydrogen streams were combined with the ammonia stream to produce a feed to the ammonia cracking reactor comprising 0 mol %, 1 mol %, 5 mol %, 10 mol %, 20 mol %, 30 mol %, 40 mol %, and 50 mol % H₂. The impact on nitriding potential, K_{N}, and overall hydrogen recovery for the flowsheet is shown in Table 1. The nitriding potential (K_{N}) is defined according to Equation 1, where “p” represents the partial pressure of the gas.

$${K}_{N} = \frac{p ( N {H}_{3} )}{{p ( {H}_{2} )}^{1.5}} \qquad Equation 1$$

TABLE 1

| | H₂ (mol %) | | | | | | | |
|---|---|---|---|---|---|---|---|---|
| | 0% | 1% | 5% | 10% | 20% | 30% | 40% | 50% |
| Inlet K_{N} | ∞ | 158.6 | 13.70 | 4.60 | 1.43 | 0.68 | 0.38 | 0.20 |
| (atm^{-1/2}) | | | | | | | | |
| Flowsheet | 74.00 | 73.92 | 73.62 | 73.24 | 71.75 | 70.27 | 68.08 | 67.04 |
| H₂ recovery | | | | | | | | |
| (%) | | | | | | | | |

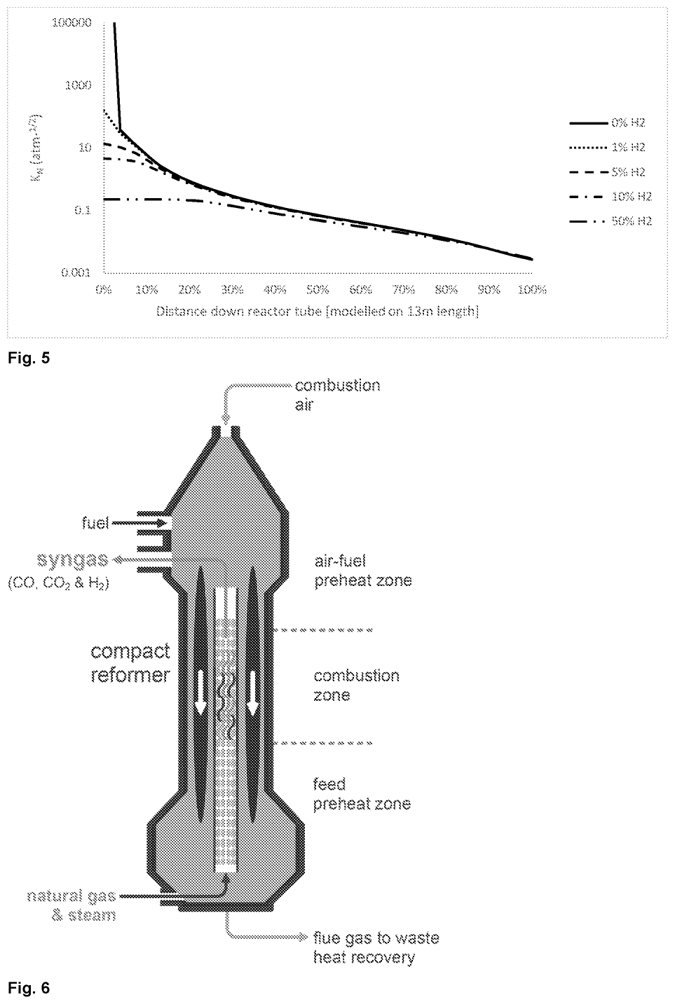

The nitriding potential along the length of a catalyst containing reaction tube was modelled for each of the hydrogen containing ammonia streams described above. The results from these models are shown in FIG. 5.

It can therefore be seen that a significant reduction in nitriding potential at the inlet of the ammonia cracking reactor may be achieved without an, or a significant, impact on the overall hydrogen recovery.

### Example 2

Example 2 concerns a fired ammonia cracking reactor being supplied with an ammonia containing stream. The ammonia containing stream enters the reactor at 550° C. and undergoes an ammonia cracking reaction to produce the hydrogen stream which comprises ammonia in an amount of ≤1.1 mol %.

In Example 2 the tail gas from a hydrogen purification unit was used as the hydrogen containing recycle gas. The amount of H₂ and N₂ in the tail gas, the impact on nitriding potential, K_{N}, and the overall hydrogen recovery for the flowsheet is shown in Table 1.

TABLE 2

| | Proportion of tails gas as recycle (%) | | | | | |
|---|---|---|---|---|---|---|
| | 0% | 10% | 20% | 30% | 40% | 50% |
| H₂ (mol %) | 0% | 1.37% | 2.52% | 3.43% | 4.1% | 4.4% |
| N₂ (mol %) | 0% | 5.01% | 10.29% | 15.85% | 21.70% | 27.8% |
| Inlet K_{N} | ∞ | 94.10 | 35.13 | 20.48 | 14.57 | 11.83 |
| (atm^{-1/2}) | | | | | | |
| Flowsheet H₂ | 74.00 | 73.90 | 73.77 | 73.38 | 72.76 | 71.80 |
| recovery (%) | | | | | | |

It can be seen from these results that when a tail gas from a purification unit used to increase the H₂ content of the hydrogen containing stream is used as the hydrogen containing recycle gas that the same significant reduction in the nitriding potential may be achieved, as in Example 1, whilst a high hydrogen recovery for the process may also be realised.

1. A process for the catalytic cracking of ammonia, the process comprising:
supplying an ammonia stream to one or more catalyst containing reaction tubes disposed within an ammonia cracking reactor;
cracking the ammonia in the ammonia stream in the one or more catalyst containing reaction tubes disposed within the ammonia cracking reactor to produce a hydrogen containing stream; and
supplying a hydrogen containing recycle gas taken from downstream of the ammonia cracking reactor to the one or more catalyst containing reaction tubes disposed within the ammonia cracking reactor.

2. The process according to claim 1, comprising the step of pre-heating the ammonia stream to a temperature of from 350° C. to 1000° C.

3. The process according to claim 1, wherein the pressure inlet to the one or more reaction tubes is in the range of 1 to 100 bar absolute, 10 to 90 bar absolute, or 31 to 51 bar absolute.

4. The process according to claim 1, wherein the hydrogen containing stream comprises from 40 mol % to 75 mol % H₂.

5. The process according to claim 1, wherein the hydrogen containing recycle gas is supplied to the one or more reaction tubes disposed within the ammonia cracking reactor such that from 0.5 mol % to 50 mol % H₂, from 1 mol % to 40 mol % H₂, from 2 mol % to 30 mol % H₂, from 4 mol % to 20 mol % H₂, or 5 mol % to 10 mol % H₂ is supplied to the one or more reaction tubes.

6. The process according to claim 1, wherein the process further comprises the step of feeding the hydrogen containing stream to a purification unit and increasing the H₂ content of the hydrogen containing stream to produce an enriched hydrogen stream and a tail gas.

7. The process according to claim 6, wherein the enriched hydrogen stream comprises from 50 mol % to 100 mol % H₂, from 60 mol % to 90 mol % H₂, or from 70 mol % to 80 mol % H₂.

8. The process according to claim 1, wherein the hydrogen containing recycle gas comprises a portion of the hydrogen containing stream.

9. The process according to claim 1, wherein the hydrogen containing recycle gas comprises a portion of the enriched hydrogen containing stream, and/or a portion of the tail gas from the purification unit.

10. The process according to claim 1, comprising the step of combusting one or more fuel streams with oxygen in a fuel combustion zone to provide heat energy to support the endothermic ammonia cracking reaction in the ammonia cracking reactor.

11. The process according to claim 10, wherein the one or more fuel streams comprise one or more of hydrogen, natural gas, methane, refinery off gas, biogas, the tail gas from the hydrogen purification unit, a portion of the hydrogen containing stream from the ammonia cracking reactor, or a portion of the enriched hydrogen containing stream from the purification unit.

12. The process according to claim 10, wherein the one or more fuel streams comprise hydrogen in an amount of from 10 mol % to 45 mol %, from 12 mol % to 35 mol %, or from 15 mol % to 25 mol %.

13. The process according to claim 10, wherein the one or more fuel streams comprise ammonia in an amount of from 10 mol % to 45 mol %.

14. The process according to claim 10, wherein the one or more fuel streams are pre-heated to a temperature of from 100° C. to the auto ignition temperature of the fuel stream prior to being combusted in the fuel combustion zone.

15. The process according to claim 6, wherein the tail gas comprises from 1 mol % to 50 mol % H₂, from 2 mol % to 40 mol % H₂, or from 15 mol % to 25 mol % H₂.

16. The process according to claim 1, wherein the one or more catalyst containing tubes are formed of an iron based alloy, a nickel based alloy, or a cobalt based alloy.

17. A process for the catalytic cracking of ammonia, the process comprising:
supplying an ammonia stream to one or more catalyst containing reaction tubes disposed within an ammonia cracking reactor;
cracking the ammonia in the ammonia stream in the one or more catalyst containing reaction tubes disposed within the ammonia cracking reactor to produce a hydrogen containing stream;
feeding the hydrogen containing stream to a purification unit and increasing the H₂ content of the hydrogen containing stream to produce an enriched hydrogen stream and a tail gas; and
supplying a hydrogen containing recycle gas taken from downstream of the ammonia cracking reactor to the one or more catalyst containing reaction tubes disposed within the ammonia cracking reactor, wherein the hydrogen containing recycle gas comprises a portion of the enriched hydrogen containing stream.
